(19) United States
(12) Patent Application Publication
(10) Pub. No.: US 2007/0248268 A1
(43) Pub. Date: Oct. 25, 2007

(54) Moment based method for feature indentification in digital images

(76) Inventor: Douglas O. Wood, New Haven, CT (US)

Correspondence Address: Pamela R. Crocker;Patent Legal Staff, Eastman Kodak Company, 343 State Street, Rochester, NY, 14650-2201, US

(21) Appl. No.: 11/409,905

(22) Filed: Apr. 24, 2006

(51) Int. Cl. G06K 9/46; G06K 9/00

(52) U.S. Cl. 382/195; 382/128

(57) ABSTRACT

A method for identifying features in digital images. The method includes, providing a digital image of a plurality of pixels having one or more features to be identified; providing a feature model having one or more parameters characteristic of a feature to be identified, wherein the feature model has a centroid; and distributing a plurality of test Regions of Interest (ROIs) over the digital image, so that every pixel of the digital image is covered by one or more test ROIs, wherein each test ROI has the same parameter(s) as the feature model, including its centroid. The method then includes for each test ROI, calculating the intensity moment of the image region bounded by the test ROI and if the centroid of the test ROI is offset from the intensity moment, moving the test ROI closer to the intensity moment and reiterating these steps until the centroid and intensity moment have substantially converged, and then processing the next test ROI; determining which ROIs are candidate ROIs; removing duplicate ROIs where two or more candidate ROIs identify the same feature; and outputting the list of candidate ROIs, the positions of which identify the features of interest in the provided image.

### FIELD OF THE INVENTION

This invention relates in general to the field of digital image processing and more particularly to a method for identifying features and patterns in a digital image.

### BACKGROUND OF THE INVENTION

In a variety of disciplines such as material science and machine vision, one often has the need to automatically identify similar features and patterns in a digital image. The goal may be to simply count the number of features, such as the number of bacterial colonies in a Petri dish containing a swab from a diseased patient. One may also want to measure the positions of each object with high accuracy or one might want to identify objects which do not match a given pattern, such as defective parts on a manufacturing line. A variety of methods have been developed to accomplish these tasks, but many are complex and require excessive computer processing time. There is thus a need for a method for identifying features and patterns in a digital image which is simple and which minimizes computer processing time.

### SUMMARY OF THE INVENTION

According to the present invention, there is provided a solution to these problems and a fulfillment of the needs discussed above.

According to a feature of the present invention, there is provided a method for identifying features in digital images comprising: providing a digital image of a plurality of pixels having one or more features to be identified; providing a feature model having one or more parameters characteristic of a feature to be identified, wherein the feature model has a centroid; distributing a plurality of test Regions of Interest (ROIs) over the digital image, so that every pixel of the digital image is covered by one or more test ROIs, wherein each test ROI has the same parameter(s) as the feature model, including its centroid; for each test ROI, calculating the intensity moment of the image region bounded by the test ROI and if the centroid of the test ROI is offset from the intensity moment, moving the test ROI closer to the intensity moment and reiterating these steps until the centroid and intensity moment have substantially converged, and then processing the next test ROI; determining which ROIs are candidate ROIs; removing duplicate ROIs where two or more candidate ROIs identify the same feature; and outputting the list of candidate ROIs, the positions of which identify the features of interest in the provided image.

The invention provides some advantages. For example, it provides a method for identifying features and patterns in a digital image. In addition, the method performs well in the presence of significant variations of the background image intensity, and reduces computer processing time.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a flow chart showing an embodiment of the method of the present invention. The two principal stages are indicated with hashed gray bounding boxes. Operations where calculations or other operations take place are indicated with rectangular boxes. Logical branches are indicated with diamonds.

FIG. 2 is a series of diagrammatic views of an aspect of the present invention.

FIG. 3 is a series of diagrammatic views of another aspect of the present invention.

FIG. 4 is a diagrammatic view of an example of the method of the invention applied to an image of bacterial colonies in a Petri dish.

### DETAILED DESCRIPTION OF THE INVENTION

The following is a detailed description of the preferred embodiments of the invention, reference being made to the drawings in which the same reference numerals identify the same elements of structure in each of the several figures.

In general, the present invention is a method for identifying features and/or patterns in a digital image. The method is normally employed with 2 dimensional images, but can also be used with images of any number of dimensions. The required inputs to the method are the digital image itself and a model (Feature Model) that describes features which the user wants to identify. The Feature Model can either be a simple geometric model (for example, a polygon, ellipse, or the like) or a image that represents the objects of interest.

The method processes the image in two stages.

In the first stage, a relatively large number of test Regions of Interest (ROIs) are distributed over the image (or a portion of the image) so that every pixel of the image is covered by one or more of the test ROIs. These ROIs are substantially the same size and shape as the input feature model. In an iterative process described below, the method uses the calculated second moment of the image intensity to minimize the geometric distance between the x and y moments of the ROI and the previously calculated centroid of the test ROIs. If a test ROI happens to have been placed near a feature of interest in the image, this iterative procedure will “walk” the test ROI until it is centered over a feature of interest in the image. After the ROI has come to “rest” (i.e., the optimization process has converged), the statistics of each test ROI are used to determine if the test ROI has found a feature with sufficient peak brightness above the background noise and sufficient total intensity in order to be considered as a real feature. If the feature is significant, the test ROI is saved to a list of candidate ROIs.

In the second stage of the process, the list of candidate ROIs is examined in a pair-wise fashion in order to eliminate candidate ROIs that appear to have located the same feature in the image.

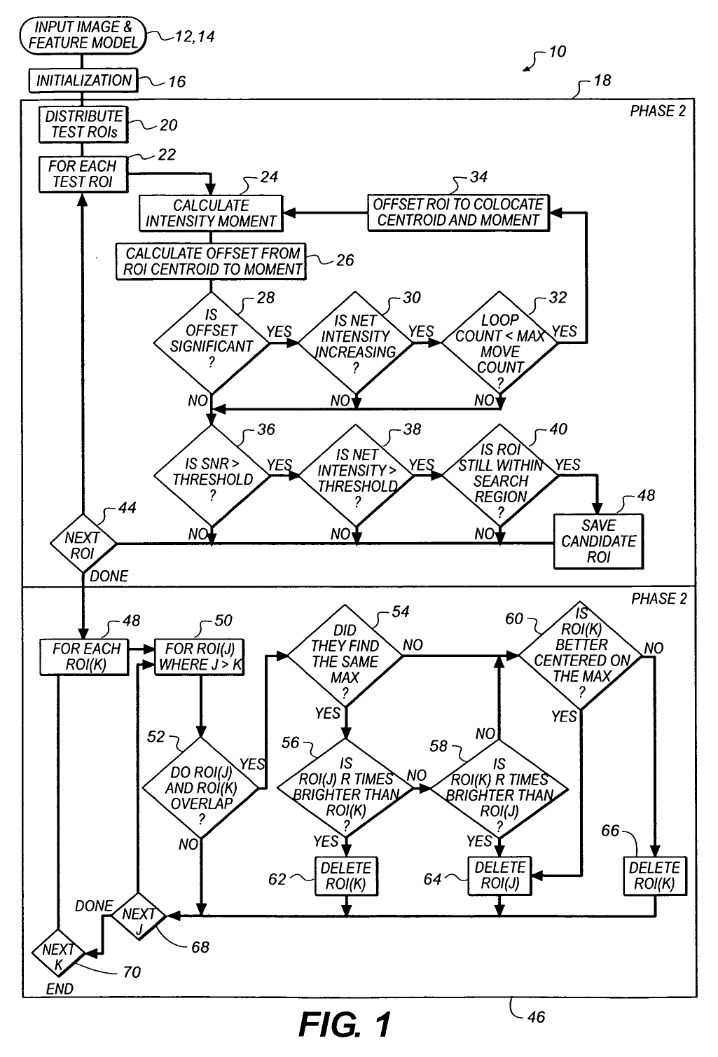

Referring to FIG. 1, there is shown an embodiment of the method of the present invention. As shown, method 10 first provides required inputs of input digital image 12 and feature model 14.

The inputs are now more particularly described.

INPUT IMAGE—The method includes providing a digital image 12 to process. This image can have more than one plane or channel (e.g., a color image with three planes or channels) and it can be of any data type (integer or floating point). In the case of a multidimensional image, each plane can be processed separately or the moment calculation (which is more particularly described below) can be extended in ways known to those skilled in the art to calculate the position of the moment in 3 or more dimensions. The input image can have any x,y dimensions such that the width and height of the image is greater than the width and height of the Feature Model described next. It is noted that the features of interest are emission features (i.e., a more positive data value in the image represents a signal of interest), but this method can be employed to process absorption images (i.e., negative going signals) with modifications of the various tests which are dependant on the orientation of the signal.

FEATURE MODEL—The method also includes providing a feature model 14. The feature model 14 provides information to the method about the size, shape and (optionally) the intensity distribution of the features of interest. In its simplest form, the feature model is a geometric shape (e.g., a polygon or ellipse). This type of feature model can be referred to as a geometric model. If desired, the method can be provided with a feature model that is essentially a small image that is typical of the features that the user wants to identify in the image. This type of model can be called an image model.

Optional parameters can be employed. That is, the input image 12 and the feature model 14 are the information required by the method. The parameters described below are optional, and can either be provided by the method, or the method can provide estimates based on the input image and the feature model.

SEARCH REGION—A rectangle or other polygon, specified in image x,y coordinates that can be used to search a portion of the image. If no search region is supplied, the search region defaults to the entire image.

FEATURE SNR—A floating point value that specifies the desired signal-to-noise ratio (SNR) that a feature must have in order to be considered significant. If no Feature SNR is specified, this parameter can default to any positive value (e.g. 3.0 or 6.0).

IMAGE NOISE—A floating point value for the root mean square deviation of the image's background noise. If the image noise level is not specified, its value can be estimated during initialization as described below. The image background noise value should include not just detector noise, but noise due to any sources that are present in the background of the image.

NET INTENSITY THRESHOLD—A floating point value that can be used to reject candidate features which do not have sufficient net intensity (=integrated intensity of the ROI after subtracting a local background intensity). If the intensity threshold is not supplied, this parameter defaults to zero.

FEATURE OVERLAP CRITERION—The maximum separation that two features can have before they are considered as separate features. If no feature overlap criterion is specified, the method can default to a value of, say one half the width and height of the specified feature model. The Feature Overlap Criterion allows the user to control how closely spaced two objects must be in order to be considered as one.

An initialization step is performed. The step in the method of the present invention, as shown in FIG. 1, is the initialization step (box 16).

During initialization, the method 10 determines default values for any unspecified parameters, and calculate a few variables that will be used later in the image processing. The optional parameter described above which does not have a simple default value is the image noise level. There are a variety of ways to estimate the image background noise. One way is to distribute a number of rectangular ROIs with an area of, say 50 pixels (in order to be statistically significant) over the entire search region. Then, calculate the RMS (root mean square) variation of each ROI and set the image background noise parameter to the RMS of the test ROI with the smallest RMS.

Next, some values are calculated that will be used in the iterative steps that follow. If the feature model is an image model, the test ROI shape is defined to have the same shape as the boundary of the image model (usually a rectangle, but the shape can be any polygon or bitmap). If the feature model is a geometric model, the same geometric shape for the test ROI shape can be employed.

With the size and shape of the test ROI defined, there is next calculated the spacing of the test ROIs that will promote that every pixel of the Search Region is covered by one or more test ROIs. A possible choice is to choose a spacing that is no more than ½ the Feature Overlap Criterion. For example, if the Feature Overlap Criterion is ½ the width of the Feature Model, then the test ROI spacing in the X direction should be no more than ¼ the Feature Model width. Likewise, the vertical spacing should be ¼ the Feature Model height or less. Choosing a much smaller test ROI spacing usually does not produce better results and since it results in more test ROIs the overall execution time of the algorithm increases.

The final step in the initialization process is to calculate the centroid of the Feature Model. If the Feature Model is a geometric model, then a practice is to choose the geometric center of the polygon. For example, for a rectangle, the centroid would have an x location of ½ the width, and a y location of ½ the height. For an ellipse or circle ROI, the centroid would be the center of the ellipse or circle. For more complicated polygons, one could place the centroid at the center of mass of the polygon. If the feature model is an image model, the centroid should simply be set to the calculated intensity moments (Equations 1 a and 1b) as described below.

In Phase 1, test ROIs are placed.

In the first phase (box 18) of the method, test ROIs are distributed over the entire Search Region (box 20), the position of each is adjusted using the calculated intensity moments of the ROI, and then those ROIs that pass the tests for SNR and total intensity are selected. For each ROI, the process is started by placing the test ROI at its initial location in the regular grid (box 22). Next, the intensity moment of the ROI is calculated (box 24). To determine the local background for the ROI at this location, there is found the mean value of all the pixels immediately adjacent to the ROI (i.e. the mean intensity of the perimeter pixels). This value is called Pₘ. Then, to calculate the x and y coordinates, Mₓ and M_{y}, of the second moment of the image intensity for the ROI at its current location, the following expressions are used:
Mₓ=Σx(I−Pₘ)²/Σ(I−Pₘ)² (Eq. 1a)
and
M_{y}=Σy(I−Pₘ)²/Σ(I−Pₘ)² (Eq. 1b)
where the sums are taken over all interior pixels of the ROI and

x=the value of the x coordinate of the pixel

y=the value of the y coordinate of the pixel

I=the intensity of the pixel

Note that the first moment of the image intensity can be used (by replacing the power of two with a power of one), but using the second moment has advantages. For example: 1) it can be used with emission or absorption images and 2), it puts greater weight on the brightest portions of the feature model which more closely resembles human visual perception.

Next (box 26), there is calculated the x and y offsets from the moments Mₓ and M_{y} by subtracting the position of the test ROI's centroid from the position of the second moment. If the offset is significant (diamond 28) (i.e. greater than 1 pixel in either x or y) and the net intensity of the test ROI is increasing (diamond 30) (i.e., the new position would result in an increase of the test ROI's net intensity) and there has not been exceeded a loop count of, for example, 10 iterations (diamond 32) (this is to encourage that the process does not get caught in an infinite loop), the ROI is offset to the new position (box 34), and this process is begun again (box 26). Each time the test ROI is offset, its centroid will move closer to the position of the intensity moment until they are the same to within one pixel.

Once the process has converged (or the loop count is exceeded) (diamonds 28, 30, 32 are “no”), there is calculated some statistics of the test ROI in its final position. To find the SNR of the test ROI, Pₘ is subtracted from the maximum intensity in the ROI and the result is divided by the assumed image noise value. Three statistical tests are then performed. If, (1) the SNR of the test ROI is greater than the SNR criterion for features (diamond 36), and (2) the net intensity of the test ROI is greater than the net intensity threshold (diamond 38), and (3) the test ROI has not wandered outside of the search region (diamond 40), this test ROI is saved (box 42) as a candidate feature identification. If any one of these tests is not met (diamonds 36, 38, and/or 40 are “no”), this test ROI is rejected and not considered further. The next test ROI is then processed (diamond 44).

After all the test ROIs have been placed at their initial grid locations and run through the process described above, there will be left a list of candidate ROIs which will be positioned at the locations of image features that resemble the input feature model and the method passes to phase 2 (diamond 44).

In Phase 2: duplicate identifications are removed (box 46).

When two test ROIs are initially placed near each other and both are partially covering a feature of interest, the iterative process of “walking” the test ROIs will result in some of the candidate ROIs finding the same feature. The purpose of phase 2 (box 46) is to remove these duplicate identifications from the list of ROI candidates.

To begin, there is selected the first candidate ROI which is compared in a pair-wise fashion with the other ROIs in the list (boxes 48, 50). With each comparison, there is first a test to determine if the distances between the centroids of the two ROIs is less than the Feature Overlap Criterion (diamond 52). If the two ROIs do overlap, the process first checks to determine if the location of the pixel with maximum brightness in each ROI is the same for both ROIs (i.e., did they both find the same local peak in the image) (54). If they did find the same peak, their net intensities are compared and whichever ROI is more than r times brighter than the other is kept (diamonds 56, 58). The value for r is not critical, but r must be greater than 1 (1.5 appears to work well).

If the two ROIs have found the same peak and have similar net intensities, the ROI that is better centered on the local image maximum is selected (diamond 60). There are a variety of ways to calculate how far an ROI is from the position of the local maximum. In practice it may be preferable to use the simple geometric distance from the peak to the centroid of the ROI. It is noted that if the two ROIs have exactly the same position, one is selected and the other is deleted. If two ROIs overlap but have found different image peaks, we again select the ROI that is better centered on the position of its own local maximum (boxes 62, 64, 66).

The method terminates (diamonds 68, 70) when all candidate ROIs have been examined for duplications. The output of the method is the list of candidate ROIs, the positions of which identify the features of interest in the image.

Optimization during Phase 1 can be employed.

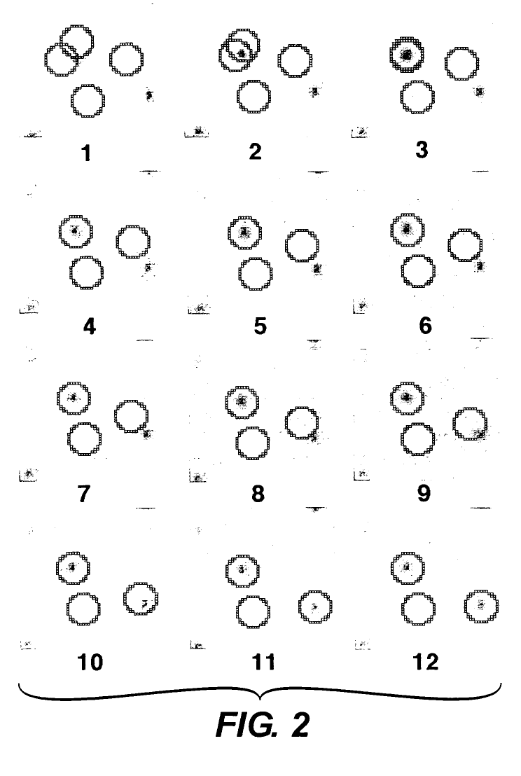

Referring now to FIG. 2, there is illustrated the optimization that takes place in Phase 1 of the method of the invention. In normal operation during Phase 1, test ROIs are placed on the image in a grid such that every pixel of the search area of the image is covered by at least one test ROI. For clarity, there is shown in this figure only four example test ROIs taken from the grid. Frame 1 shows the initial positions of each of the four example test ROIs. Frame 2 shows the position of each test ROI after one iteration in Phase 1. Going from Frame 1 to Frame 2, each test ROI has been offset so that its geometric centroid is coincident with the ROI's intensity moment calculated in Frame 1. Frame 3 shows the results after the second iteration after each test ROI was offset to the position of the intensity moment calculated in Frame 2. Note that the two test ROIs that started out near an image feature are beginning to converge on the same feature. This process continues, so that by Frame 4 these two test ROIs have found the same feature in the image, even though they started at different initial positions in the grid. Note that the test ROI in the bottom left corner has not moved because it happens to lay in a relatively “flat” region of the image (its centroid and intensity moment are already coincident). Note that the test ROI on the far right side of the frame is still moving with each iteration. Frames 5 through 12 show subsequent iterations. By Frame 12, the last ROI has “walked” its way over to the feature in the bottom right quadrant of the frame. At the end of the iteration for each test ROI in Phase 1, if the test ROI did locate a feature (within the given SNR and net intensity thresholds), it can be saved to the list of candidate ROIs, otherwise it would be deleted. Of these four example test ROIs, three would be saved, and the ROI that does not find a feature is deleted.

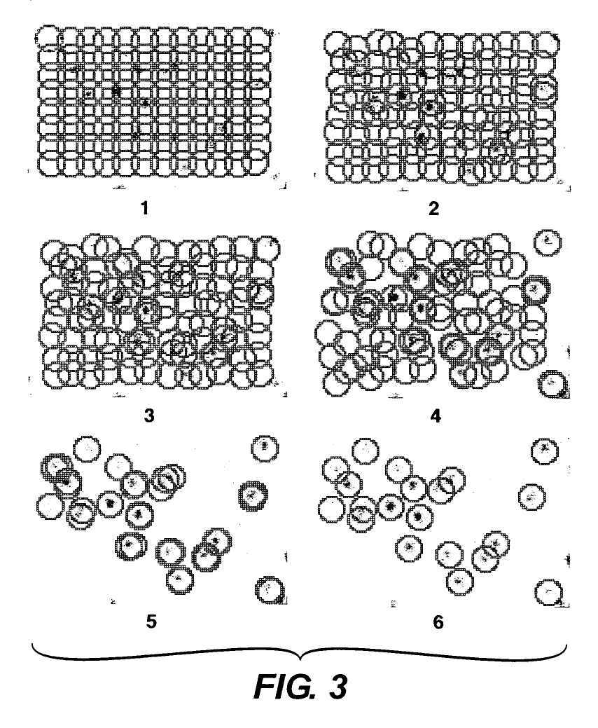

FIG. 3 shows an overview of the method of the invention. More particularly, FIG. 3 is a diagrammatic view showing the processing of an example grid of 96 test ROIs. Frames 1 through 4 take place in Phase 1 of the method as shown in FIG. 1. They show the same processing that was applied in FIG. 2, except that in FIG. 3 all 96 test ROIs in the search region are shown. By Frame 4, all ROIs have converged (for this example, the largest number of iterations was 12, and most ROIs converged in 3-4 iterations). In Frame 5, the test ROIs that did not meet the specified SNR or Net Intensity thresholds have been removed. Normally, this is done after each ROI has converged, rather than after the entire grid has been processed, but this detail has no effect on the results. The ROIs pictured in Frame 5 represent the list of candidate ROIs that is the input to Phase 2. Frame 6 shows the results of processing in Phase 2. If two candidate ROIs have exactly the same position, one is deleted. If two candidate ROIs overlap one another, one is deleted according to the method described above and in FIG. 1. The result is a list of 20 ROIs that demark the locations of the features of interest.

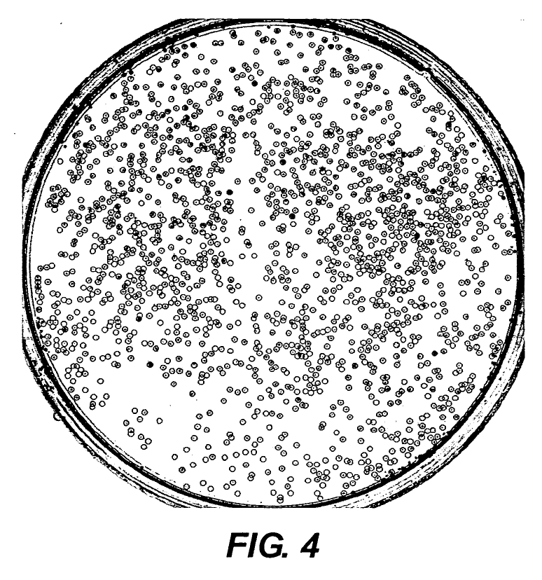

FIG. 4 provides an example of the method of the invention applied to an image of bacterial colonies in a Petri dish.

More particularly, FIG. 4 shows an example of the results obtained when the method of the present invention is applied to an image of bacterial colonies growing in a Petri dish. A circular geometry model with a diameter of 9 pixels was used. A total of 1704 ROIs were found within the circular search region. It is noted that the method of the invention performs well in congested areas and even though the background has a 20% change in mean brightness across the image.

It is noted that the method as described above requires some information about the features of interest. If the objects one is trying to find in an image are not rotationally symmetric (e.g., oval shapes instead of circles), the method may not perform well at identifying objects that have a different orientation than that of the feature model. This may be the situation if the objects are very asymmetric (needles vs. coins) and can assume any orientation in the image. The method can be modified, however, to account for feature rotation by placing more than one test ROI at each grid initial grid location. These additional test ROIs can have a range of orientations, taking any symmetry of the feature model into account. For example, if one wishes to find elliptical objects with any possible orientation, one can place 17 test ROIs at each initial grid location, and rotating each elliptical ROI by 10°. Note that there has been taken into account that rotating an ellipse by 180° results in the same ellipse. During Phase 2, the ellipse that has the closest orientation to the actual orientation of the feature should be selected over the others because that ROI will have the greatest net intensity (e.g., it is a better match to the image brightness variations). Similarly, it is possible to take size variations of the features into account, by placing additional test ROIs with a range of sizes.

It is noted that the method of the invention is reasonably insensitive to the large scale variations in the background of the image since each test ROI takes the local background into account by using the mean value of its perimeter pixels when calculating the x and y moments. However, if the background in the image has very large variations or steep intensity gradients, this can produce non-optimal results because the gradients may cause the ROIs to “walk” in the direction of the gradient. To reduce this effect, one can subtract from the image a copy of the image that has been processed with a low pass or minimum filter with a kernel size that is much larger than the size of the features of interest.

The invention has been described in detail with particular reference to certain preferred embodiments thereof, but it will be understood that variations and modifications can be effected within the spirit and scope of the invention.

### PARTS LIST

10—method
12—input image
14—feature model
16, 18, 20, 22, 24, 26—operation boxes
28, 30, 32—logical branch diamonds
34—operation box
36, 38, 40—logical branch diamonds
42—operation box
44—logical branch diamond
46, 48, 50—operation boxes
52, 54, 56, 58, 60—logical branch diamonds
62, 64, 66—operation boxes
68, 70—logical branch diamonds

What is claimed is:

1. A method for identifying features in digital images, comprising the steps of:
providing a digital image of a plurality of pixels having one or more features to be identified;
providing a feature model having one or more parameters characteristic of a feature to be identified, wherein the feature model has a centroid;
distributing a plurality of test Regions of Interest (ROIs) over the digital image, so that every pixel of the digital image is covered by one or more test ROIs, wherein each test ROI has the same parameter(s) as the feature model, including its centroid;
for each test ROI, calculating the intensity moment of the image region bounded by the test ROI and if the centroid of the test ROI is offset from the intensity moment, moving the test ROI closer to the intensity moment and reiterating these steps until the centroid and intensity moment have substantially converged, and then processing the next test ROI;
determining which ROIs are candidate ROIs;
removing duplicate ROIs where two or more candidate ROIs identify the same feature; and
outputting the list of candidate ROIs, the positions of which identify the features of interest in the provided image.

2. The method of claim 1 wherein the feature model is a geometric shape called a geometric model.

3. The method of claim 2 wherein the geometric shape of the feature model is one of a polygon, circle, or ellipse.

4. The method of claim 1 wherein the feature model is a small image that is typical of the features to be identified in the provided image and is called an image model.

5. The method of claim 2 wherein the centroid of the geometric model is the center of the geometric shape.

6. The method of claim 4 wherein the centroid of the image model is set to calculated intensity moments.

7. The method of claim 1 wherein the spacing between adjacent test ROIs is a function of the maximum separation two features can have before they must be considered as separate features, referred to as the Feature Overlap Criterion.

8. The method of claim 7 wherein the Feature Overlap Criterion is no more than ½ the width and height of the feature model.

9. The method of claim 1 wherein the calculated intensity moment is the second moment of the image intensity.

10. The method of claim 9 wherein the second moment of image intensity is calculated according to:
Mₓ=Σx(I−Pₘ)²/Σ(I−Pₘ)²
and
M_{y}=Σy(I−Pₘ)²/Σ(I−Pₘ)²
wherein the sums are taken over all interior pixels of the ROI and;
x=the value of the x coordinate of the pixel
y=the value of the y coordinate of the pixel
I=the intensity of the pixel
Pm=the mean value of all of the pixels immediately adjacent to the test ROI (i.e., the mean intensity of the perimeter pixels).

11. The method of claim 1 wherein the calculated image intensity is the first moment of the image intensity.

12. The method of claim 1 wherein the provided digital image is one of an emission image or an absorption image.

13. The method of claim 1 wherein the moving of the test ROI is based on whether the offset between the centroid and the intensity moment is greater than 1 pixel in the x and or y direction, whether the net intensity of the test ROI is increasing, and whether the number of iterations has not exceeded a predetermined number.

14. The method of claim 1 wherein in the determining which ROIs are candidate ROIs, an ROI is selected as a candidate ROI if, (a) the SNR (Signal-to-Noise-Ratio) of the test ROI is greater than a SNR threshold, (b) the net intensity of the test ROI is greater than a net intensity threshold, and (c) the test ROI is still within the search region.

15. The method of claim 1 wherein in the removing duplicate ROIs, each candidate ROI is compared each other candidate ROI, and if the distance between the centroids of the two ROIs is less than a predetermined distance, and if the location of the pixel with the maximum brightness in each ROI is the same for both ROIs, the candidate ROI is chosen that has net intensity which is a predetermined factor greater than the other, but if the two candidate ROIs have substantially the same net intensities, the candidate ROI is chosen that is better centered on the local image maximum.

16. The method of claim 1 wherein the features to be identified are not rotationally symmetric, and wherein in distributing test ROIs over the digital image, feature rotation is accounted for by placing more than one test ROI at each location having different orientations.

17. The method of claim 1 wherein the features to be identified have different sizes, and wherein in distributing test ROIs over the digital image, feature size variation is accounted for by placing additional test ROIs at each location having a range of sizes.

18. The method of claim 1 wherein, if the background of the provided digital image has very large variations or steep intensity gradients, the effect can be reduced by subtracting from the digital image, a copy of the digital image that has been processed with a low pass or minimum filter with a kernel size that is much larger than the size of the features of interest.
